(19) United States
(12) Patent Application Publication
(10) Pub. No.: US 2004/0216553 A1
(43) Pub. Date: Nov. 4, 2004

(54) Hollow rotating shaft

(76) Inventor: Helmut Kirmsse, Liechtenstein (DE)

Correspondence Address: Dr. Max Fogiel, 44 Maple Court, Highland Park, NJ, 08904, US

(21) Appl. No.: 10/854,610

(22) Filed: May 26, 2004

(30) Foreign Application Priority Data
Dec. 7, 2001 (DE) 101 60 246.4
Nov. 7, 2002 (WO) PCT/EP02/12414

(51) Int. Cl. F16H 53/00

(52) U.S. Cl. 74/567

(57) ABSTRACT

The invention relates to a hollow shaft. The aim of the invention is to mount, with as little complication as possible, a component (2) head-on on the peripheral surface of a shaft that is at least sectionally configured as a hollow shaft (1) and to leave as much space as possible for hydraulics channels passing through the shaft. According to the invention, the shaft is mechanically flared by means of an axially movable device and a support (4) for said axially movable device is mounted within the hollow shaft (1) or the hollow section of the shaft in a radially positive or non-positive manner.

The present invention concerns either a hollow rotating shaft or the hollow section of an otherwise solid rotating shaft that is mechanically expanded to fasten various components to its outer surface.

Shafts of this genus are frequently employed as transmission shafts or camshafts. British 2 050 207 discloses the manufacture of a hollow camshaft that is mechanically expanded to fasten various components to its outer surface. An arbor travels axially all the way through the shaft, expanding it and fastening the components to its outer surface.

This method requires complicated tooling, leads to considerable wear on the expanding head, and takes a lot of time. Furthermore, the shaft is likely to buckle.

Other methods of manufacturing camshafts, especially hollow camshafts, have accordingly prevailed. Axially slipping the cams over elevated sections of the shaft (German 4 121 951 C1) and hydraulic expansion (U.S. Pat. No. 3,977,068) have been proven economical. Components like cogwheels and chain-drive wheels can be simultaneously mounted at the ends of the shaft, especially a camshaft, by the same procedure, either mechanical or hydraulic expansion.

It is often necessary to not mount such shaft-end components as cogwheels and chain-drive wheels and even camshaft-adjustment mechanisms on a camshaft until the later has already been installed in the engine block. Such components are usually screwed and/or keyed to the shaft. A potential drawback here is that very complicated fasteners will be necessary when the component, a shaft-adjustment mechanism for example, has to be provided with hydraulic connections that extend through the shaft. Associated problems are the scarcity of space to accommodate the hydraulic connections and the very severe stress on the conventional central fastening screws.

One object of the present invention is accordingly a hollow shaft or the hollow end of an otherwise solid shaft that a component can be fastened by simple means to the head-end outer surface of while leaving as much space as possible for hydraulic connections to extend through. Another object of the invention is a simple method of fastening the component to the shaft.

This object is attained in a hollow rotating shaft or end thereof of the aforesaid genus in accordance with the present invention as recited in the body of claim 1 herein. Claims 2 through 12 address practical alternative and advanced embodiments, claim 13 recites a method of manufacturing a hollow shaft in accordance with claims 2 through 12, claim 14 recites machinery for carrying out the method in accordance with claim 13, and claim 15 recites an advanced version of the method in accordance with claim 1 employing the machinery in accordance with claim 14.

The method in accordance with the present invention has several advantages.

It can be employed with simple means and without severe axial forces on an already installed camshaft for instance.

Again, an additional component can be mounted subsequently on the end of a shaft that has already been provided with other components.

Channels, especially axial fluid-conveying channels, can be introduced into the end of the shaft with simple means and without demanding too much space. Any adjustment component that will need to be mounted on the camshaft can accordingly be reliably and rapidly controlled without demanding much space.

Finally, since only weak axial joining forces will be necessary when camshaft-adjustment components, drivewheels, or other shaft end components are mounted on a camshaft already installed in a cylinder head, the camshafts can be warehoused flat without being damaged.

One embodiment of the present invention will now be specified with reference to the accompanying drawing, wherein

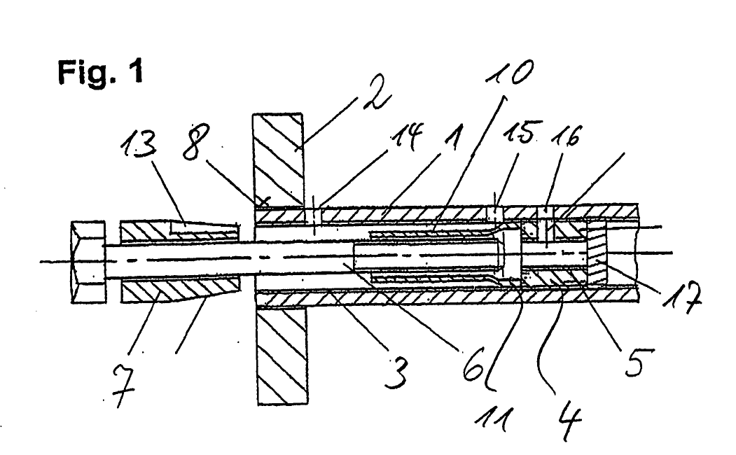

FIG. 1 is a section through one end of a hollow rotating shaft before a component has been mounted on its outer surface,

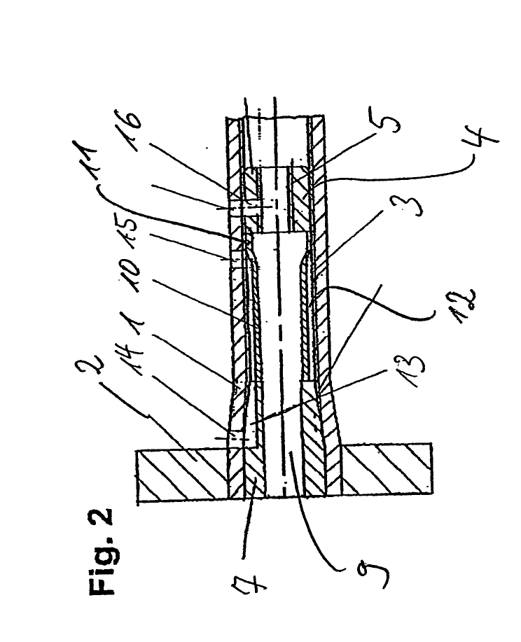

FIG. 2 depicts the same end once a component has been mounted on that surface,

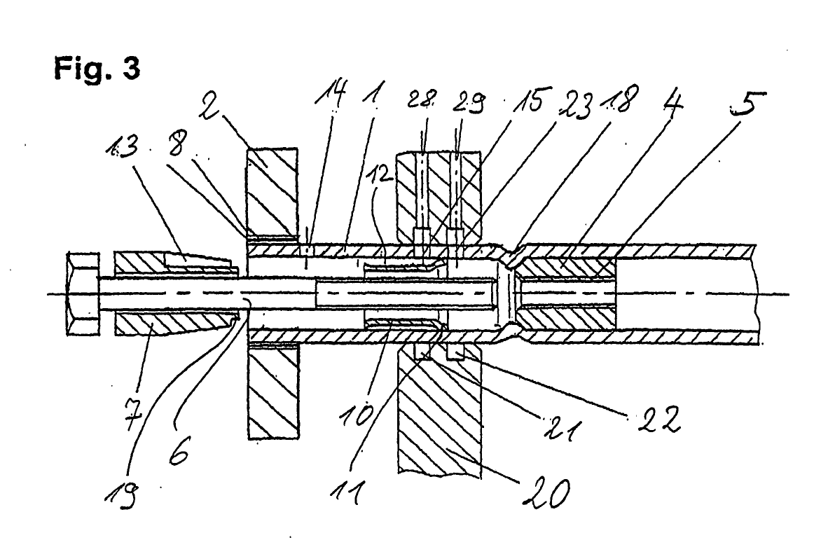

FIG. 3 is a section similar to that in FIG. 1 but also illustrating a camshaft bearing,

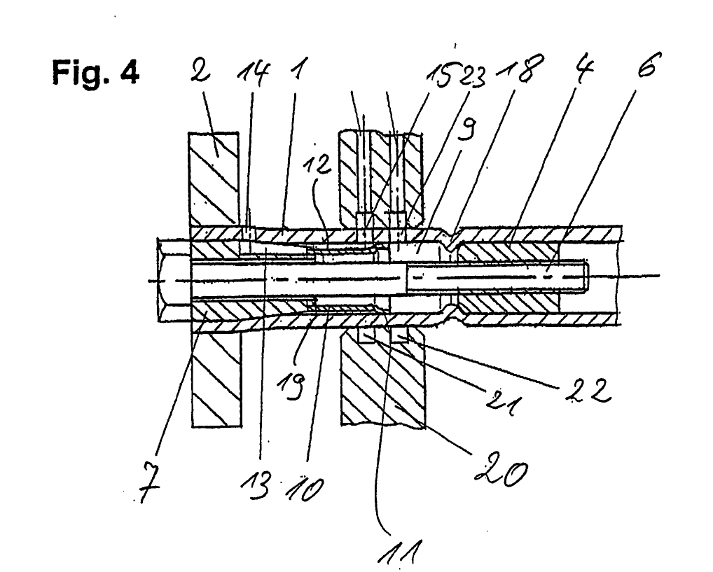

FIG. 4 depicts the component illustrated in FIG. 3 in conjunction with FIG. 2, and

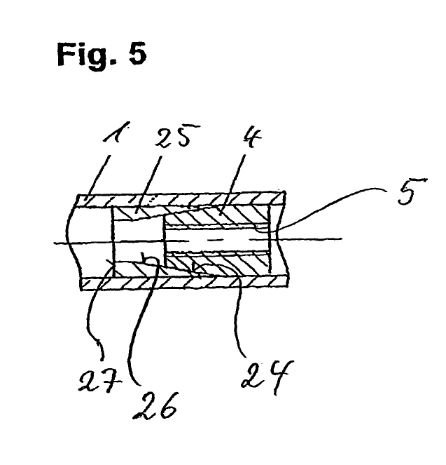

FIG. 5 is a section through a hollow shaft farther from the end, illustrating another approach to fastening a reinforcement.

The figures represent the present invention as applied to an at least partly hollow camshaft. The camshaft is finished except for a final component that still needs to be added to its outer surface. Cams and some other components of the shaft have already been fastened to it by mechanically forcing them over a wider section thereof or by local hydraulic expansion. The present text will accordingly be confined to specifying the mounting of one or more components to a shaft in the aforesaid state. Other species of hollow shafts, e.g. driveshafts and steering posts, can be similarly manufactured. It is also possible by this method to mount such components as camshaft-adjustment components on the hollow end of an otherwise solid shaft, a forged or cast camshaft for example.

One end of a hollow camshaft 1 is illustrated in FIG. 1. The conventional components of a camshaft, e.g. the cams, are not illustrated. Such a camshaft can also be solid or provided with a hollow end.

A component 2—a cogwheel, disk, or the hub of a camshaft adjustment component in the present example—is to be mounted on one end of camshaft 1. This is to be accomplished in accordance with the present invention by mechanically expanding the shaft in the vicinity of component 2. The shaft has for this purpose been provided with an inside-threaded section 3. A reinforcement 4 in the form of a bushing has been screwed into the threaded section to a prescribed distance. Reinforcement 4 itself is also provided with an inside-threaded section 5. As represented in FIG. 1, component 2 is brought into alignment with camshaft 1. A threaded bolt 6 with an arbor 7 slipped over its outer end is screwed into the threaded section 5. As bolt 6 enters section 5, a conical structure on the face of arbor 7 enters camshaft 1 and expands the section of it inside component 2, plasticly and elastically deforming it radially and expanding the inner surface 8 of the component at least elasticly and even plasticly, producing a pressure weld between the shaft and the component, which will accordingly be force-fit together. If camshaft 1 or component 2 are provided with appropriate structures, e.g. ridges or grooves, or if the inner cross-section of the component is eccentric, the component can be form-fit as well as force-fit to the shaft.

FIG. 2 depicts the same end of camshaft 1 with component 2 fastened to it. It will also be evident from this figure that threaded bolt 6 can be extracted from the shaft once assembly is complete. Arbor 7, however, will remain inside camshaft 1, still supporting the pressure weld between it and component 2. The access bore and the space inside the threaded section 5 of reinforcement 4 can now be exploited as a hydraulic-fluid supply channel 9. In one alternative version of the illustrated embodiment, arbor 7 can be provided with an extension allowing it to be screwed directly into the threaded section 5 of reinforcement 4. In this event no threaded bolt will be necessary. Another alternative employs a spindle in the assembling machinery instead of a threaded bolt. The advantage of this approach is the absence of a separate arbor-advancing part that can be mislaid. Once arbor 7 has arrived in its specified position adjacent to component 2, the spindle will travel back out. When the assembly is carried out mechanically, the machine's head can also be secured to reinforcement 4 by alternative means, e.g. by a bayonet connection. Arbor 7 can in this event be subjected to the force of a hydraulic or pneumatic piston.

To create additional fluid-supply channels, arbor 7 can be provided with an extension 10 comprising one or more parts. The extension 10 in the illustrated embodiment comprises two cylindrical parts and, once the shaft has been assembled, will be positioned upstream of the inner end of arbor 7. The end of extension 10 proximate to the shaft is provided with a bell 11 that, in the illustrated example, rests radially tight against the face of reinforcement 4. Extension 10 was introduced into camshaft 1 before arbor 7 was forced in. When it is integrated into arbor 7 in a single part, extension 10 will of course have been introduced along with the arbor.

Final assembly of the embodiment illustrated in FIG. 2 will leave an annular channel 12 between extension 10 and camshaft 1. Annular channel 12 opens into a channel 13 in arbor 7. Radial bores 14 and 15 through camshaft 1 extend annular channel 12 and the adjacent channel 13 outward through camshaft 1. Appropriate hydraulic means can be attached to the shaft at this point. Just as extension 10 can be cylindrical, it can also be provided with longitudinal undulations, providing several axial channels that can be exploited for various purposes.

Fluid-supply channel 9 communicates hydraulically with a component mounted on the shaft through another bore, bore 16, that extends radially through camshaft 1 and reinforcement 4.

If necessary, the threaded section 5 of reinforcement 4 can, as represented in FIG. 1, be provided with a cap 17, at least during the early stage of assembly.

The aforesaid connection not only allows fluid-supply channels to be simultaneously exploited to supply a camshaft-adjustment component with fluid but provides significant advantages in so doing in that the total flow-through cross-section will be considerably larger than it would be if the adjustment component were fastened to the end of the camshaft by such conventional means as keying or a central screw. The larger flow-through cross section allows either more precise adjustment at a lower pressure difference, resulting in less turbulence and hence in less fluidic loss or even cavitation, or more rapid adjustment at constant fluid pressure. Another advantage of this approach is that the communication between the camshaft and the camshaft-adjustment component can be maintained throughout the life of the engine. Such a long-lasting connection cannot be guaranteed if the camshaft-adjustment component is screwed into place.

The aforesaid fastening means can be employed not only in camshafts that are hollow all the way through but also for solid camshafts that have been cast, forged, or otherwise fabricated, whereby the shaft need only be provided with a hollow end for supplying fluid to the adjustment component. In this event, reinforcement 4 will of course be the end of the solid section of the shaft.

FIGS. 3 and 4 illustrate slightly different versions of the hollow rotating shaft illustrated in FIGS. 1 and 2 before and after assembly.

Basic to the design of the shaft illustrated in FIGS. 3 and 4 is that it lacks inside threading. Reinforcement 4 rests axially against an inward-elevated bead 18, and must be introduced into the shaft either before the bead is created or when possible from the other end.

The extension 10 of arbor 7 rests tight against the inner surface of camshaft 1 only by way of bell 11. In contrast to the embodiment illustrated in FIGS. 1 and 2, extension 10 does not extend all the way up to reinforcement 4, nor is it positioned in front of arbor 7, but radially by way of an elevation 19 on the end of the arbor. In this embodiment as well, extension 10 constitutes in conjunction with the inner surface of camshaft 1 an annular channel 12 that opens into a channel 13 in arbor 7. As in FIGS. 1 and 2, radial bores 14 and 15 extending through camshaft 1 provide outward communication for annular channel 12 and channel 13. Another channel is provided by way of a bore 23 that connects the inside of the shaft, fluid-supply channel 9, with the atmosphere. This channel is completely unblocked once threaded bolt 6 has been extracted. Bores 15 and 23 act in conjunction with annular groves 21 and 22 in the cylinder-head camshaft bearing 20. Annular groves 21 and 22 are supplied with fluid from the cylinder head by way of bores 28 and 29 for delivery to an unillustrated camshaft-adjustment component.

Providing the inner surface of camshaft 1 with threading, roller burnishing, rifling, or knurling will be of advantage in the assembly of high-precision work. In this embodiment, the work need not exhibit such precise tolerances in that any tolerances will be compensated by the aforesaid means. The same is true of similar measures in relation to the inner surface of component 2 or to the outer surface of camshaft 1. As arbor 7 is forced into camshaft 1, the peaks of the roller-burnished or threaded surface are initially flattened until the reduced flattening force prevents further plastic deformation thereof. The camshaft 1 is now expanded at tensional equilibrium. Once the shaft's outer surface has been expanded enough to reach the inner surface of component 2, the flattening force will be increased discontinuously, with expansion continuing. The grooves or threading can accordingly flatten farther again until the force decreases again below the plastic-deformation limit of the marks. Here as well there will be tensional equilibrium between the recuperative tensions in component 2 and the flattened roller burnishing or threading.

The resulting tolerance compensation can be optimized by the mass of the burnished areas.

As illustrated in FIG. 4, threaded bolt 6 can, if fluid-supply channel 9 is not needed, also be allowed to remain inside the shaft, hydraulically closing the shaft off from the atmosphere.

The machinery employed as illustrated in FIG. 5 to mechanically expand camshaft 1 to match a particular component 2 can be applied at any point along the shaft. The reinforcement 4 in this embodiment is provided with a conical outer surface 24. A slotted or unslotted bushing 25 with a matching conical inner surface 26 can be employed in conjunction with reinforcement 4. The unillustrated threaded bolt is provided with an outward stop that rests against the outer face 27 of bushing 25. As the bolt enters the threaded section 5 inside reinforcement 4, the conical inner surface 26 of bushing 25 will slide over the conical outer surface 24 of reinforcement 4 and will accordingly automatically expand while also expanding camshaft 1, forcing an unillustrated component located at that point against the shaft.

The bushing 25 in one particular embodiment can, as illustrated in FIG. 4, be part of extension 10. In this event, tightening threaded bolt 6 will tension reinforcement 4 while simultaneously sealing off channels 12 and 9.

### List of Parts

1. shaft

2. component

3. threaded section

4. reinforcement

5. threaded section

6. bolt

7. arbor

8. inner surface

9. fluid-supply channel

10. extension

11. bell

12. annular channel

13. channel

14. bore

15. bore

16. bore

17. cap

18. bead

19. elevation

20. bearing

21. annular channel

22. annular channel

23. bore

24. conical outer surface

25. bushing

26. conical inner surface

27. face

28. bore

29. bore

1. At least sectionally hollow rotating shaft with a component (2) fastened by an axially traveling tool to its outer surface by mechanical expansion, characterized by a reinforcement (4) for the tool accommodated radially tight or interlocking inside the shaft (1) or its hollow section.

2. Shaft as in claim 1, wherein the reinforcement (4) is a bushing with an axial inside-threaded section (5).

3. Shaft as in claim 1, wherein the reinforcement (4) has an outside-threaded section and is screwed into an inside-threaded section (3) of the shaft.

4. Shaft as in claim 1, wherein the reinforcement (4) rests axially against an inward-directed bead (18) inside the shaft.

5. Shaft as in claim 1, wherein it has a solid section and a hollow end, which the reinforcement (4) is part of.

6. Shaft as in claim 5, wherein either its inner surface or its outer surface or both, at least within the component (2), or the inner surface of the component (2) or both is or are knurled or roller burnished or provided with a machined or molded threaded section.

7. Shaft as in claim 1, characterized in that an arbor (7) with an outer conical expansion surface is forced into it in the vicinity of the component (2) mounted thereon.

8. Shaft as in claim 7, wherein the arbor (7) is provided with a longitudinal central bore.

9. Shaft as in claim 7, wherein the arbor (7) is provided with a single-part or multiple-part extension (10) that extends into the shaft, whereby the end of the extension rests all the way around radially against the bore through the center of the shaft and axially against the reinforcement (4).

10. Shaft as in claim 9 wherein the arbor (7) or the extension (10) or both is or are provided with one or more channels (12 & 13) that extend axially along the shaft.

11. Shaft as in claim 10, wherein the channels (12 & 13) open into radial breaches, preferably in the form of bores (14 & 15) that extend through it.

12. Shaft as in claim 1, wherein it is a camshaft and in that the component (2) fastened to its outer surface is a camshaft-adjustment component.

13. Method of manufacturing a shaft as in claim 2, characterized in that, once the reinforcement (4) has been introduced and the component (2) slipped over the shaft (1), the arbor (7) is forced into the shaft inside the component by a head provided with an outside-threaded section or with an appropriate extension thereof that fits into the inside-threaded section (5) of the reinforcement (4).

14. Machinery for carrying out the method recited in claim 13, characterized in that the part that forces the arbor (7) in is a threaded pin or bolt (6).

15. Machinery as in claim 14, wherein the threaded pin or bolt (6) is removed once the arbor (7) is in place.
